(19) United States
(12) Patent Application Publication
(10) Pub. No.: US 2026/0250115 A1
(43) Pub. Date: Aug. 27, 2026

(54) METHOD AND APPARATUS FOR INFUSING BOTTLED WATER USING SOUND VIBRATIONS

(71) Applicant: Brian Adams, Davie, FL (US)

(72) Inventor: Brian Adams, Davie, FL (US)

(21) Appl. No.: 19/062,156

(22) Filed: Feb. 25, 2025

(51) Int. Cl. B67C 3/22; G10K 11/16; H04R 3/04

(52) U.S. Cl. CPC B67C 3/22; G10K 11/16; H04R 3/04; B67C 2003/226

(57) ABSTRACT

An apparatus for infusing bottled water using sound vibrations is disclosed. The apparatus includes a container designed to retain fluid. A sonic chamber allows the container to be positioned therein and includes a sound resonating system positioned to emit a frequency at about 528 Hz to the fluid to reconfigure the fluid in accordance with cymatic principles. A method for infusing bottler water using sound vibrations is also disclosed wherein fluid is dispensed into a container which is positioned within the sonic chamber. A sound resonating system emits a frequency for a predetermined period of time to enable the propagation of the frequency through the fluid to induce the alteration of the molecular structure of the fluid.

### TECHNICAL FIELD

The embodiments generally relate to a method and apparatus for restructuring and infusing water on a molecular level using the science of cymatics.

### BACKGROUND

Water is essential to life and exhibits unique physical and chemical properties. Recent studies have suggested that water can be influenced by sound frequencies through a phenomenon known as cymatics. Cymatics is the study of wave phenomena, particularly the visualization of sound vibrations on a medium such as water, revealing patterns and structures created by sound frequencies.

It is well-documented that specific frequencies can have an impact on biological systems and water structuring. Among these, 528 Hz is known as the “Miracle Frequency” or “DNA Repair Frequency,” which has been theorized to influence water positively by altering its molecular arrangement. Despite these findings, there is a lack of practical applications that harness cymatics in a controlled and reproducible manner for bottled water processing.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to an apparatus for infusing bottled water using sound vibrations is disclosed. The apparatus includes a container designed to retain fluid. A sonic chamber allows the container to be positioned therein and includes a sound resonating system positioned to emit a frequency at about 528 Hz to the fluid to reconfigure the fluid in accordance with cymatic principles.

The embodiments also provide a method for infusing bottler water using sound vibrations, wherein fluid is dispensed into a container which is positioned within the sonic chamber. A sound resonating system emits a frequency for a predetermined period of time to enable the propagation of the frequency through the fluid to induce the alteration of the molecular structure of the fluid.

In some aspects, the sonic chamber is sound dampened.

In some aspects, the sonic chamber prevents light from entering an interior of the sonic chamber.

In some aspects, an interior of the sonic chamber provides a temperature-controlled environment.

In some aspects, the temperature-controlled environment is about 70° Fahrenheit.

In some aspects, the sound resonating system includes a frequency generator to emit the frequency via music.

In some aspects, the sound resonating system includes a transducer and an amplifier to emit the frequency above the fluid to enable the propagation of the frequency through the fluid to induce the alteration of a molecular structure of the fluid.

These and other objects, features, and advantages of the present invention will become more readily apparent from the attached drawings and the detailed description of the preferred embodiments, which follow.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the sonic chamber and sound resonating system to emit a predetermined frequency to alter the molecular structure of fluid within a container, according to some embodiments;

FIG. 2 illustrates a block diagram of a sound resonating system, according to some embodiments; and

FIG. 3 illustrates a flowchart of a method for infusing bottled water using cymatic principles.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to an apparatus, system, and method for infusing bottled water with music at the frequency of 528 Hz using specialized sound-resonating equipment in a sonic chamber, restructuring the water on a molecular level over a prolonged period. The embodiments include a system, method and apparatus for infusing bottled water using sound waves and music at a frequency of 528 Hz, which is achieved by placing the water in a specially designed, sound damped, darkened sonic chamber at 70 degrees Fahrenheit. This method uses sound-resonating equipment that directs sound waves from above the water container, allowing the frequency to pass through the water. The process is conducted for at least than 24 hours (one skilled in the arts will readily understand that lesser amount of time may be possible based on various conditions and parameters), ensuring the water is infused and its molecular structure is reconfigured in accordance with cymatics principles.

The invention can be applied to various types of water, including mineral, spring, and purified water. The resulting water is believed to exhibit improved taste, increased hydration potential, and enhanced biological compatibility due to the restructuring effect of the 528 Hz frequency.

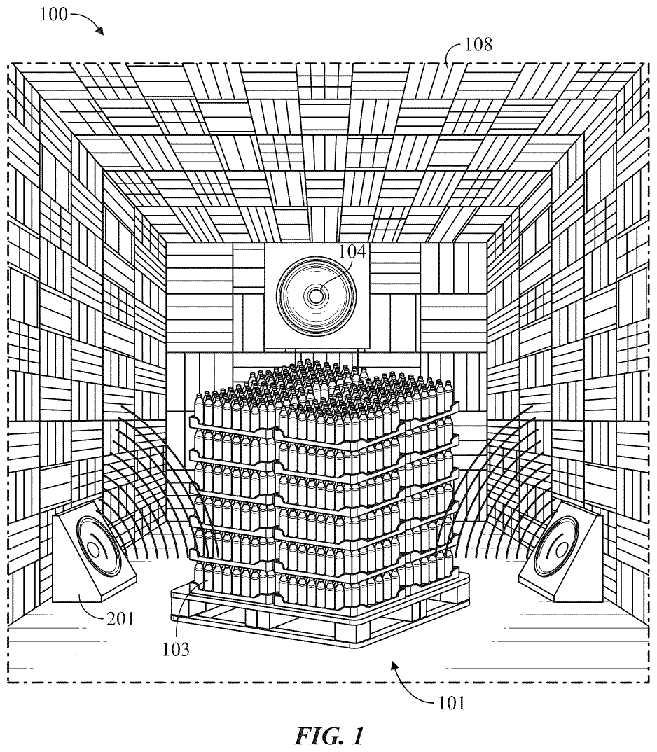

FIG. 1 illustrates a perspective view of an environment 100 which depicts a sonic chamber 101 capable of containing one or more containers 103 therein. The containers 103 may be a plurality of bottles containing water or a similar fluid 105 therein. The sonic chamber 101 includes a sound resonating system 104 which is capable and positioned to emit a frequency of sound at about 528 z to reconfigure the molecular structure of the fluid in accordance with cymatic principles. The sonic chamber 101 includes noise dampening elements 108 such as padding, a textures surface, sound dampening materials and/or other elements which are positioned within the sonic chamber 101 to dampen sound from external and/or internal environments. The sonic chamber 101 may include one or more speakers 201 which emit the frequency. The sonic chamber 101 may also provide a temperature or otherwise environmentally controlled environment. The sonic chamber 101 may also include means for preventing or controlling the amount of light within the sonic chamber 101.

In some embodiments, the sonic chamber 101 may be integrates with the container 103, such as for example a water bottle having the capability of emitting a frequency (e.g., 528 Hz) which can reconfigure the molecular structure of the fluid.

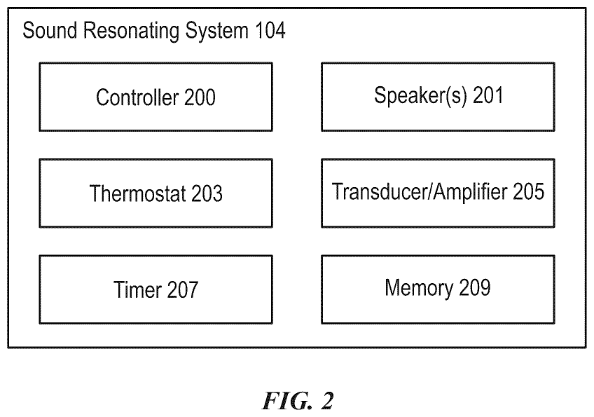

FIG. 2 illustrates a block diagram of the sound resonating system 104 which includes a controller 200 in operable communication with a memory 209 configured to store operational instructions of the system, such as for example, instructions which can be sent to one or more speakers 201, a thermostat 203, a transducer and amplifier 205, and a timer 207. The controller 200 may include a user interface to allow the user to input operational instructions which set a time period for the sound to be emitted, set a frequency to be emitted, adjust the thermostat to control the temperature in the environment within the sound chamber, etc.

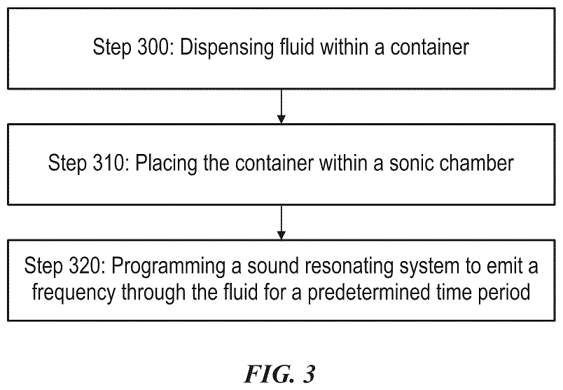

FIG. 3 illustrates a flowchart of a method for infusing bottled water using sound vibrations. In step 300, fluid is dispensed within the container and the container is placed within a sonic chamber in step 310. In step 320, the sound resonating system is programmed to emit a frequency (preferentially at about 528 Hz) to reconfigure the molecular structure of the fluid.

In an alternative method, a container having a sound resonating system integrated into its own housing may emit the frequency. This may be useful for a personal-use container, insulated cup, or similar re-usable container used to store and consume fluids.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. An apparatus for infusing bottled water using sound vibrations, the apparatus comprising:
a container designed to retain a fluid therein;
a sonic chamber capable of containing the container therein; and
a sound resonating system positioned to emit a frequency at about 528Hz to the fluid to reconfigure the fluid in accordance with cymatic principles.

2. The apparatus of claim 1, wherein the fluid is water.

3. The apparatus of claim 1, wherein the sonic chamber includes a sound dampening element.

4. The apparatus of claim 1, wherein the container is positioned within the sonic chamber.

5. The apparatus of claim 1, wherein the sound dampening element reduces external noise in an interior of the sonic chamber.

6. The apparatus of claim 1, wherein the sonic chamber prevents light from entering an interior of the sonic chamber.

7. The apparatus of claim 1, wherein the interior of the sonic chamber provides a temperature-controlled environment.

8. The apparatus of claim 7, wherein the temperature-controlled environment is about 70° Fahrenheit.

9. The apparatus of claim 1, wherein the sound resonating system includes a frequency generator to emit the frequency via music.

10. The apparatus of claim 9, wherein the sound resonating system includes a transducer and an amplifier to emit the frequency above the fluid to enable the propagation of the frequency through the fluid to induce the alteration of a molecular structure of the fluid.

11. A method for infusing bottled water using sound vibrations, the method comprising the steps of:
dispensing a fluid within a container;
placing the container within a sonic chamber; and
programming a sound resonating system to emit a frequency through the fluid for a predetermined period of time to enable the propagation of the frequency through the fluid to induce alteration of a molecular structure of fluid.

12. The method of claim 11, wherein the fluid is water.

13. The method of claim 11, wherein the sonic chamber includes a sound dampening element.

14. The method of claim 11, wherein the sonic chamber prevents light from entering an interior of the sonic chamber.

15. The method of claim 11, wherein an interior of the sonic chamber provides a temperature-controlled environment.

16. The method of claim 11, wherein the temperature-controlled environment is about 70° Fahrenheit.

17. The method of claim 11, wherein the sound resonating system includes a frequency generator to emit the frequency via music.

18. A system for infusing bottled water using sound vibrations, the system comprising:
at least one container to retain a fluid therein; and
a sonic chamber to receive the at least one container, the sonic chamber including a sound resonating system, the sound resonating system including an amplifier and a transducer to emit a sound frequency of 528 Hz for at least 24-hours to enable the propagation of the frequency through the fluid to induce the alteration of a molecular structure of fluid.
